(19) United States
(12) Patent Application Publication
(10) Pub. No.: US 2025/0303731 A1
(43) Pub. Date: Oct. 2, 2025

(54) VALVE MECHANISM, LIQUID FLUID DEVICE, AND LIQUID EJECTION DEVICE

(71) Applicant: SEIKO EPSON CORPORATION, Tokyo (JP)

(72) Inventors: Yuki HIRABAYASHI, SHIOJIRI-SHI (JP); Tomohiro KAWASAKI, SHIOJIRI-SHI (JP); Masaru KOBASHI, MATSUMOTO-SHI (JP)

(21) Appl. No.: 19/090,855

(22) Filed: Mar. 26, 2025

(30) Foreign Application Priority Data
Mar. 27, 2024 (JP) 2024-051312
Jun. 5, 2024 (JP) 2024-091544
Jun. 5, 2024 (JP) 2024-091545
Jun. 5, 2024 (JP) 2024-091546

(51) Int. Cl. B41J 2/175; B41J 2/17

(52) U.S. Cl. CPC B41J 2/17596; B41J 2/1707; B41J 2/17523

(57) ABSTRACT

It includes a first upstream chamber, a first downstream chamber that includes a first flexible membrane and that is in communication with the first upstream chamber via a first communication port downstream from the first upstream chamber, a second flexible membrane that partitions the first upstream chamber and the first downstream chamber from each other, a first open and close section configured to open and close the first communication port, a first biasing section that biases the first flexible membrane, wherein the first open and close section includes a first shaft section that is provided across the first upstream chamber and the first downstream chamber and that is configured to move following displacement of the first flexible membrane and the second flexible membrane and a first valve section that opens and closes the first communication port.

The present application is based on, and claims priority from JP Application Serial Number 2024-051312, filed Mar. 27, 2024, JP Application Serial Number 2024-091545, filed Jun. 5, 2024, JP Application Serial Number 2024-091546, filed Jun. 5, 2024, and JP Application Serial Number 2024-091544, filed Jun. 5, 2024, the disclosures of which are hereby incorporated by reference herein in their entirety.

### BACKGROUND

### 1. Technical Field

The present disclosure relates to a valve mechanism, a liquid fluid device, and a liquid ejection device.

### 2. Related Art

For example, as in JP-A-2012-86535, there is a printer, which is an example of a liquid ejection device that performs printing by ejecting ink, which is an example of a liquid, from a recording head, which is an example of a liquid ejection section. The printer includes a pressure control valve, which is an example of a valve mechanism. The pressure control valve includes a valve chamber, a pressure chamber, and an elastic partition wall.

Ink supplied from an ink cartridge is sent to the valve chamber. When the pressure in the pressure chamber drops, the elastic partition wall deforms and opens an open and close valve. When the open and close valve opens, liquid flows from the valve chamber to the pressure chamber, and the liquid is sent from the pressure chamber to the recording head.

Pressure in the valve chamber is applied to the open and close valve of JP-A-2012-86535. Therefore, there is a possibility that the pressure at which the open and close valve opens may vary.

### SUMMARY

A valve mechanism that solves the above problem includes an upstream chamber into which fluid flows via an inflow port; a downstream chamber that has a first flexible membrane and that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction of increasing volume of the downstream chamber, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

A valve mechanism that solves the above problem includes an upstream chamber that has a first flexible membrane and into which a fluid flows via an inflow port; a downstream chamber that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction of decreasing volume of the upstream chamber, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

A liquid fluid device that solves the above problem includes a liquid storage section configured to store liquid; a liquid flow path coupled to the liquid storage section; a pressure varying mechanism configured to vary the pressure of liquid flowing through the liquid flow path; and the valve mechanism configured as described above.

A liquid ejection device that solves the above problem includes a liquid fluid device with the above configuration and a liquid ejection section configured to eject liquid.

### BRIEF DESCRIPTION OF THE DRAWINGS

FIG. 1 is a schematic view of a first embodiment of a liquid ejection device.

FIG. 2 is a schematic cross-sectional view of a first valve mechanism included in the liquid ejection device.

FIG. 3 is a schematic cross-sectional view of a second valve mechanism included in the liquid ejection device.

FIG. 4 is a schematic view of a second embodiment of a liquid ejection device.

FIG. 5 is a schematic view of a first modification of the liquid ejection device.

FIG. 6 is a schematic view of a second modification of the liquid ejection device.

FIG. 7 is a schematic view of a third modification of the liquid ejection device.

FIG. 8 is a schematic view of a fourth modification of the liquid ejection device.

FIG. 9 is a schematic view of a fifth modification of the liquid ejection device.

FIG. 10 is a schematic view of a sixth modification of the liquid ejection device.

FIG. 11 is a schematic view of a seventh modification of the liquid ejection device.

FIG. 12 is a schematic view of an eighth modification of the liquid ejection device.

FIG. 13 is a schematic view of a ninth modification of the liquid ejection device.

FIG. 14 is a schematic view of a tenth modification of the liquid ejection device.

FIG. 15 is a schematic view of an eleventh modification of the liquid ejection device.

FIG. 16 is a schematic view of a twelfth modification of the liquid ejection device.

FIG. 17 is a schematic view of a thirteenth modification of the liquid ejection device.

FIG. 18 is a schematic view of a fourteenth modification of the liquid ejection device.

FIG. 19 is a schematic view of a fifteenth modification of the liquid ejection device.

### DESCRIPTION OF EMBODIMENTS

### First Embodiment

Hereinafter, a first embodiment of a valve mechanism, a liquid fluid device, and a liquid ejection device will be described with reference to the drawings. A liquid ejection device is, for example, an inkjet printer that performs printing by ejecting ink, which is an example of a liquid, onto a medium such as paper, fabric, vinyl, plastic components, or metal components.

In the drawings, assuming that a liquid ejection device 11 is placed on a horizontal plane, the direction of gravity is indicated by a Z axis, and directions along the horizontal plane are indicated by an X axis and a Y axis. The X-axis, the Y-axis, and the Z-axis are orthogonal to each other. In the following description, a direction parallel to the Z-axis is also referred to as a vertical direction Z.

### Liquid Ejection Device

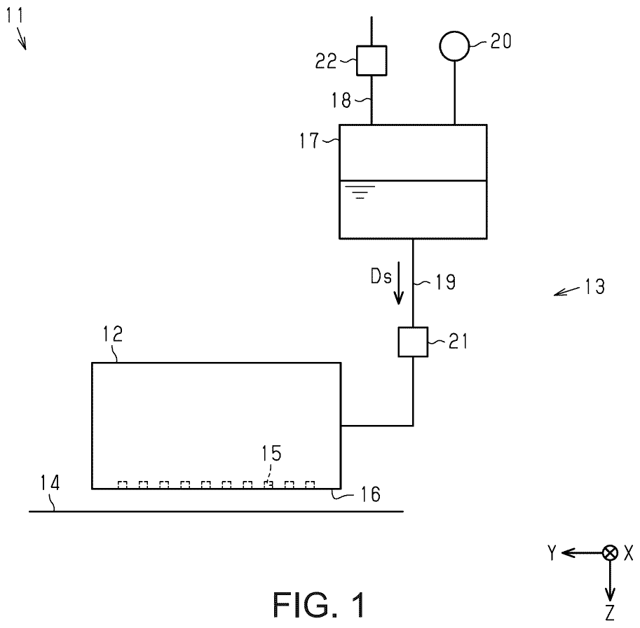

As shown in FIG. 1, the liquid ejection device 11 includes a liquid ejection section 12 and a liquid fluid device 13.

The liquid ejection section 12 is capable of ejecting liquid. The liquid ejection section 12 is configured to eject liquid onto a medium 14. The liquid ejection section 12 has a nozzle surface 16 in which one or more nozzles 15 are opened. The liquid ejection section 12 ejects liquid from the nozzles 15. The inside of the liquid ejection section 12 is normally maintained at a negative pressure. This is for forming a meniscus in the nozzles 15. Accordingly, the liquid ejection section 12 can appropriately eject liquid.

### Liquid Fluid Device

The liquid fluid device 13 supplies liquid to the liquid ejection section 12 by causing the liquid to flow. The liquid fluid device 13 may include a liquid storage section 17, a gas flow path 18, a liquid flow path 19, a pressurizing pump 20, which is an example of a pressure varying mechanism, a first valve mechanism 21, which is an example of a valve mechanism, and a second valve mechanism 22, which is an example of a valve mechanism.

The liquid storage section 17 stores liquid. The liquid storage section 17 is, for example, a tank that can be refilled with liquid.

The gas flow path 18 is connected to the liquid storage section 17. One end of the gas flow path 18 of the present embodiment is connected to the liquid storage section 17, and the other end is open to atmosphere.

The liquid flow path 19 is connected to the liquid storage section 17. The upstream end of the liquid flow path 19 with respect to a supply direction Ds is connected to the liquid storage section 17. The downstream end of the liquid flow path 19 with respect to the supply direction Ds is connected to the liquid ejection section 12. The liquid flow path 19 brings the liquid storage section 17 and the liquid ejection section 12 into communication with each other. Communication refers to connection in a state in which a fluid such as a liquid or a gas can flow. The liquid flow path 19 connects the liquid storage section 17 and the liquid ejection section 12 in a state in which liquid can flow. The liquid flow path 19 sends the liquid flowing out from the liquid storage section 17 to the liquid ejection section 12.

The pressurizing pump 20 can pressurize the inside of the liquid storage section 17. For example, the pressurizing pump 20 may pressurize the inside of the liquid storage section 17 by sending air into the liquid storage section 17. When the pressurizing pump 20 pressurizes the inside of the liquid storage section 17, the pressure of the liquid flowing out from the liquid storage section 17 increases. That is, the pressurizing pump 20 changes the pressure of the liquid flowing through the liquid flow path 19.

The first valve mechanism 21 is provided in the liquid flow path 19. The first valve mechanism 21 adjusts the negative pressure at the liquid ejection section 12 side in the liquid flow path 19.

The second valve mechanism 22 is provided in the gas flow path 18. The second valve mechanism 22 is connected to the liquid storage section 17. The second valve mechanism 22 can adjust the pressure in the liquid storage section 17. The second valve mechanism 22 adjusts the positive pressure in the liquid storage section 17 by releasing pressure in the liquid storage section 17.

### First Valve Mechanism

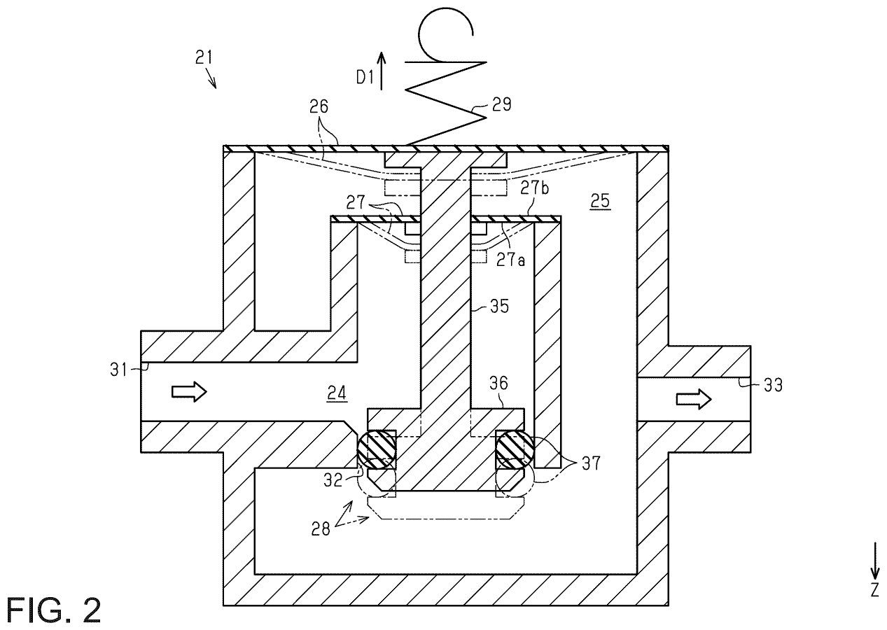

As shown in FIG. 2, the first valve mechanism 21 includes a first upstream chamber 24, which is an example of an upstream chamber, and a first downstream chamber 25, which is an example of a downstream chamber. The first downstream chamber 25 has a first flexible membrane 26. The first valve mechanism 21 includes a second flexible membrane 27, a first open and close section 28, which is an example of an open and close section, and a first biasing section 29, which is an example of a biasing section. The first open and close section 28 is movable between a first closed position indicated by solid line in FIG. 2 and a first open position indicated by two-dot chain line in FIG. 2. In the present embodiment, a state where the first open and close section 28 is located in the first closed position is also referred to as a first closed state, and a state where the first open and close section 28 is located in the first open position is also referred to as a first open state. In FIG. 2, the direction in which the fluid flows is indicated by white arrows.

The first upstream chamber 24 has a first inflow port 31, which is an example of an inflow port. The first inflow port 31 of the present embodiment communicates with the liquid storage section 17 via the liquid flow path 19. The fluid flows into the first upstream chamber 24 via the first inflow port 31. The fluid handled by the first valve mechanism 21 of the present embodiment is a liquid.

The first downstream chamber 25 is provided downstream of the first upstream chamber 24. Downstream of the first upstream chamber 24, the first downstream chamber 25 communicates with the first upstream chamber 24 via a first communication port 32, which is an example of a communication port. The first downstream chamber 25 has a first outflow port 33 through which the fluid flows out. The first outflow port 33 of the present embodiment communicates with the liquid ejection section 12 via the liquid flow path 19. The first flexible membrane 26 forms a part of a wall of the first downstream chamber 25. The first flexible membrane 26 is formed of a flexible member having flexibility, such as a diaphragm. The first flexible membrane 26 is displaced according to a difference in pressures applied to the outer surface and the inner surface. A differential pressure between atmospheric pressure and the biasing force of the first biasing section 29 is applied to the outer surface of the first flexible membrane 26. The pressure of the fluid in the first downstream chamber 25 is applied to the inner surface of the first flexible membrane 26. The first flexible membrane 26 in the first closed state indicated by solid line in FIG. 2 is slightly bent. In the first closed state, the first flexible membrane 26 may be in an unbent state or may be in a slightly bent state. The bending amount of the first flexible membrane 26 when the first open and close section 28 is in the first closed state indicated by solid line in FIG. 2 may be smaller than the bending amount of the first flexible membrane 26 when the first open and close section 28 is in the first open state indicated by two-dot chain line in FIG. 2.

The second flexible membrane 27 partitions the first upstream chamber 24 and the first downstream chamber 25 from each other. The second flexible membrane 27 may be located above the first communication port 32. The second flexible membrane 27 is positioned between the first communication port 32 and the first flexible membrane 26. The first communication port 32, the second flexible membrane 27, the first flexible membrane 26, and the first biasing section 29 may be arranged in this order in the first direction D1. The first direction D1 may be a direction opposite to the vertical direction Z.

The second flexible membrane 27 is displaced according to the difference between the pressures applied to a first surface 27a and a second surface 27b. The first surface 27a is applied with pressure of the fluid in the first upstream chamber 24. The second surface 27b is applied with pressure of the fluid in the first downstream chamber 25. The bending amount of the second flexible membrane 27 when the first open and close section 28 is in the first closed state indicated by solid line in FIG. 2 may be smaller than the bending amount of the second flexible membrane 27 when the first open and close section 28 is in the first open state indicated by two-dot chain line in FIG. 2.

The first open and close section 28 may include a first shaft section 35, which is an example of a shaft section, and a first valve section 36, which is an example of a valve section. The first valve section 36 may include a first seal section 37, which is an example of a seal section. The first open and close section 28 can open and close the first communication port 32.

The first shaft section 35 is provided across the first upstream chamber 24 and the first downstream chamber 25. The first shaft section 35 is inserted into the second flexible membrane 27. The longitudinal direction of the first shaft section 35 may be parallel to the first direction D1. The first shaft section 35 may be rod-shaped. The first shaft section 35 may be cylindrical. The diameter of the first shaft section 35 is smaller than the inner diameter of the first communication port 32.

The first shaft section 35 is movable following the displacement of the first flexible membrane 26 and the second flexible membrane 27. The first shaft section 35 is fixed to the first flexible membrane 26 and to the second flexible membrane 27 directly or via a fixing member. One end of the first shaft section 35 is connected to the first flexible membrane 26. The other end of the first shaft section 35 is connected to the first valve section 36. The first shaft section 35 displaces the second flexible membrane 27 and the first valve section 36 by moving following the displacement of the first flexible membrane 26.

The first valve section 36 is connected to the first shaft section 35. The first valve section 36 can open and close the first communication port 32. The first valve section 36 can restrict the flow of the fluid from the first upstream chamber 24 toward the first downstream chamber 25. The first valve section 36 moves together with the first shaft section 35. When the first open and close section 28 is in the closed position indicated by solid line in FIG. 2, the first valve section 36 blocks communication between the first upstream chamber 24 and the first downstream chamber 25. When the first open and close section 28 is in the open position indicated by two-dot chain line in FIG. 2, the first valve section 36 enables communication between the first upstream chamber 24 and the first downstream chamber 25.

The first seal section 37 can intimately contact the first communication port 32. The first seal section 37 forms an outer periphery of the first valve section 36. The first seal section 37 may be annular. The first seal section 37 may be a toroidal O-ring.

The first biasing section 29 biases the first flexible membrane 26 in the first direction D1 in which the volume of the first downstream chamber 25 increases. The first biasing section 29 is provided outside the first downstream chamber 25. The first biasing section 29 pulls the first open and close section 28 via the first flexible membrane 26. The first biasing section 29 is, for example, a tension spring.

### Operation of First Valve Mechanism

The first valve mechanism 21 reduces the pressure of the fluid flowing into the first upstream chamber 24 and causes the fluid to flow out from the first downstream chamber 25. The pressure of the fluid flowing out from the first downstream chamber 25 is negative. The pressure of the fluid flowing into the first upstream chamber 24 is a higher pressure than the pressure of the fluid flowing out of the first downstream chamber 25. The fluid flowing into the first upstream chamber 24 may have either a negative or a positive pressure.

The first open and close section 28 moves in accordance with fluctuation in the pressure in the first downstream chamber 25. When the negative pressure in the first downstream chamber 25 increases, the first flexible membrane 26 is displaced against the biasing force of the first biasing section 29, in a direction in which the volume of the first downstream chamber 25 decreases. The first open and close section 28 moves by being pushed by the first flexible membrane 26. The second flexible membrane 27 is displaced along with the first open and close section 28. The second flexible membrane 27 is displaced in a direction in which the volume of the first upstream chamber 24 is decreased and the volume of the first downstream chamber 25 is increased. The second flexible membrane 27 reduces changes in the volume of the first downstream chamber 25 that accompany displacement of the first flexible membrane 26.

The first open and close section 28 is pushed by the first flexible membrane 26 to move to the open position. Therefore, the first upstream chamber 24 is brought into communication with the first downstream chamber 25. The fluid is supplied from the first upstream chamber 24 to the first downstream chamber 25.

When the negative pressure in the first downstream chamber 25 decreases, the first flexible membrane 26 is pulled by the first biasing section 29 and displaced in the direction in which the volume of the first downstream chamber 25 increases. The first open and close section 28 and the second flexible membrane 27 move to the closed position together with the first flexible membrane 26. Therefore, the supply of the fluid from the first upstream chamber 24 to the first downstream chamber 25 is stopped.

In the first upstream chamber 24, the pressure receiving area of the first valve section 36 may be the same as the pressure receiving area of the second flexible membrane 27. The area where the first valve section 36 contacts the fluid in the first upstream chamber 24 may be substantially the same as the area where the second flexible membrane 27 contacts the fluid in the first upstream chamber 24. In this case, even when the pressure in the first upstream chamber 24 increases, the first open and close section 28 does not move from the closed position.

### Second Valve Mechanism

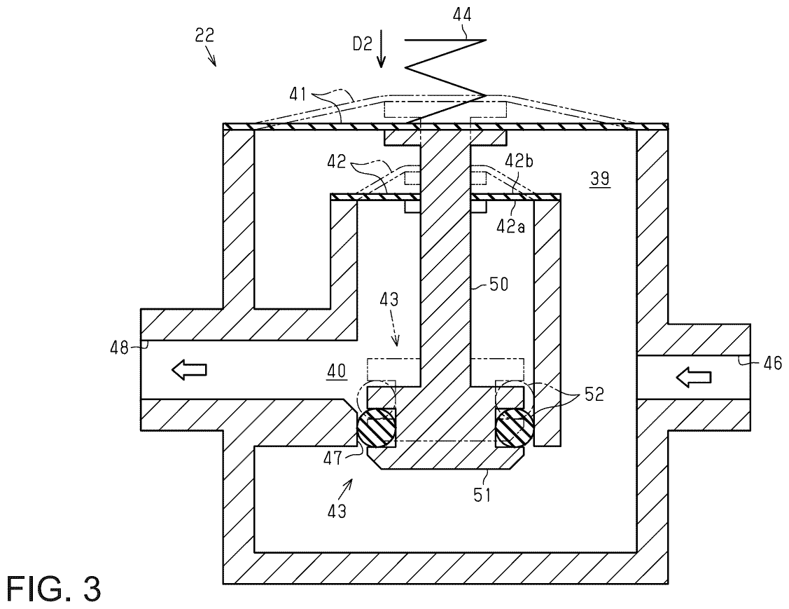

As shown in FIG. 3, the second valve mechanism 22 includes a second upstream chamber 39, which is an example of an upstream chamber, and a second downstream chamber 40, which is an example of a downstream chamber. The second upstream chamber 39 includes a third flexible membrane 41, which is an example of a first flexible membrane. The second valve mechanism 22 includes a fourth flexible membrane 42, which is an example of a second flexible membrane, a second open and close section 43, which is an example of an open and close section, and a second biasing section 44, which is an example of a biasing section. The second open and close section 43 is movable between a second closed position indicated by solid line in FIG. 3 and a second open position indicated by two-dot chain line in FIG. 3. In the present embodiment, a state where the second open and close section 43 is located in the second closed position is also referred to as a second closed state, and a state where the second open and close section 43 is located in the second open position is also referred to as a second open state.

The second upstream chamber 39 has a second inflow port 46, which is an example of an inflow port through which fluid flows in. The second inflow port 46 of the present embodiment is connected to the liquid storage section 17 via the gas flow path 18. The fluid flows into the second upstream chamber 39 via the second inflow port 46. The fluid handled by the second valve mechanism 22 of the present embodiment is a gas.

The second downstream chamber 40 is provided downstream of the second upstream chamber 39. Downstream of the second upstream chamber 39, the second downstream chamber 40 communicates with the second upstream chamber 39 via a second communication port 47, which is an example of a second communication port. The second downstream chamber 40 has a second outflow port 48 through which the fluid flows out. The second outflow port 48 of the present embodiment communicates with atmosphere via the gas flow path 18. The second outflow port 48 may be opened directly to atmosphere.

The third flexible membrane 41 forms a part of the wall of the second upstream chamber 39. The third flexible membrane 41 is formed of a flexible member having flexibility such as a diaphragm. The third flexible membrane 41 is displaced according to differences in pressure applied to the outer surface and the inner surface. The total of the atmospheric pressure and the biasing force of the second biasing section 44 is applied to the outer surface of the third flexible membrane 41. The pressure of the fluid in the second upstream chamber 39 is applied to the inner surface of the third flexible membrane 41. In the second closed state shown by solid line in FIG. 3, the third flexible membrane 41 is slightly bent. In the second closed state, the third flexible membrane 41 may be in a state of not being bent, or may be in a state of being slightly bent. The bending amount of the third flexible membrane 41 when the second open and close section 43 is in the second closed state indicated by solid line in FIG. 3 may be smaller than the bending amount of the third flexible membrane 41 when the second open and close section 43 is in the second open state indicated by two-dot chain line in FIG. 3.

The fourth flexible membrane 42 partitions the second upstream chamber 39 and the second downstream chamber 40. The fourth flexible membrane 42 may be located above the second communication port 47. The fourth flexible membrane 42 is positioned between the second communication port 47 and the third flexible membrane 41. The second biasing section 44, the third flexible membrane 41, the fourth flexible membrane 42, and the second communication port 47 may be arranged in this order in the second direction D2. The second direction D2 may be a direction opposite to the vertical direction Z.

The fourth flexible membrane 42 is displaced according to the difference between the pressures applied to a third surface 42a and a fourth surface 42b. The pressure of the fluid in the second downstream chamber 40 is applied to the third surface 42a. The pressure of the fluid in the second upstream chamber 39 is applied to the fourth surface 42b. The bending amount of the fourth flexible membrane 42 when the second open and close section 43 is in the second closed state indicated by solid line in FIG. 3 may be smaller than the bending amount of the fourth flexible membrane 42 when the second open and close section 43 is in the second open state indicated by two-dot chain line in FIG. 3.

The second open and close section 43 may include a second shaft section 50, which is an example of a shaft section, and a second valve section 51, which is an example of a valve section. The second valve section 51 may include a second seal section 52, which is an example of a seal section. The second open and close section 43 can open and close the second communication port 47.

The second shaft section 50 is provided across the second upstream chamber 39 and the second downstream chamber 40. The second shaft section 50 is inserted into the fourth flexible membrane 42. The longitudinal direction of the second shaft section 50 may be parallel to the second direction D2. The second shaft section 50 may be rod-shaped. The second shaft section 50 may have a columnar shape. The diameter of the second shaft section 50 is smaller than the inner diameter of the second communication port 47.

The second shaft section 50 is movable following displacement of the third flexible membrane 41 and the fourth flexible membrane 42. The second shaft section 50 is fixed to the third flexible membrane 41 and to the fourth flexible membrane 42 directly or via a fixing member. One end of the second shaft section 50 is connected to the third flexible membrane 41. The other end of the second shaft section 50 is connected to the second valve section 51. The second shaft section 50 displaces the fourth flexible membrane 42 and the second valve section 51 by moving following displacement of the third flexible membrane 41.

The second valve section 51 is connected to the second shaft section 50. The second valve section 51 can open and close the second communication port 47. The second valve section 51 can restrict the flow of fluid from the second upstream chamber 39 toward the second downstream chamber 40. The second valve section 51 moves together with the second shaft section 50. When the second open and close section 43 is in the closed position indicated by solid line in FIG. 3, the second valve section 51 blocks communication between the second upstream chamber 39 and the second downstream chamber 40. When the second open and close section 43 is in the open position indicated by two-dot chain line in FIG. 3, the second valve section 51 brings the second upstream chamber 39 and the second downstream chamber 40 into communication with each other.

The second seal section 52 can intimately contact the second communication port 47. The second seal section 52 forms the outer periphery of the second valve section 51. The second seal section 52 may be annular. The second seal section 52 may be a toroidal O-ring.

The second biasing section 44 biases the third flexible membrane 41 in the second direction D2 in which the volume of the second upstream chamber 39 decreases. The second biasing section 44 is provided outside the second upstream chamber 39. The second biasing section 44 presses the second open and close section 43 via the third flexible membrane 41. The second biasing section 44 is, for example, a compression spring.

### Operation of Second Valve Mechanism

The second valve mechanism 22 reduces the pressure of the fluid flowing into the second upstream chamber 39 and causes the fluid to flow out from the second downstream chamber 40. The pressure of the fluid flowing into the second upstream chamber 39 is a positive pressure. The pressure of the fluid flowing out from the second downstream chamber 40 is lower than the pressure of the fluid flowing into the second upstream chamber 39. The pressure in the second downstream chamber 40 may be negative pressure, atmospheric pressure, or positive pressure.

The second open and close section 43 moves in accordance with fluctuation of the pressure in the second upstream chamber 39. When the positive pressure in the second upstream chamber 39 increases, the third flexible membrane 41 is displaced against the biasing force of the second biasing section 44, in a direction in which the volume of the second upstream chamber 39 increases. The second open and close section 43 moves by being pulled by the third flexible membrane 41. The fourth flexible membrane 42 is displaced along with the second open and close section 43. The fourth flexible membrane 42 is displaced in a direction in which the volume of the second upstream chamber 39 is decreased and the volume of the second downstream chamber 40 is increased. The fourth flexible membrane 42 reduces changes in the volume of the second upstream chamber 39 that accompany displacement of the third flexible membrane 41.

The second open and close section 43 is pulled by the third flexible membrane 41 and moves to the open position. Therefore, the second upstream chamber 39 is brought into communication with the second downstream chamber 40. The fluid flows out from the second upstream chamber 39 to the second downstream chamber 40.

When the positive pressure in the second upstream chamber 39 decreases, the third flexible membrane 41 is pressed by the second biasing section 44 and is displaced in a direction in which the volume of the second upstream chamber 39 decreases. The second open and close section 43 and the fourth flexible membrane 42 move to the closed position together with the third flexible membrane 41. Therefore, the outflow of the fluid from the second upstream chamber 39 to the second downstream chamber 40 is stopped.

In the second downstream chamber 40, the pressure receiving area of the second valve section 51 may be the same as the pressure receiving area of the fourth flexible membrane 42. The area where the second valve section 51 contacts fluid in the second downstream chamber 40 may be substantially the same as the area where the fourth flexible membrane 42 contacts fluid in the second downstream chamber 40. In this case, even if the pressure in the second downstream chamber 40 changes, the second open and close section 43 does not move from the closed position.

### Operation of First Embodiment

The operation of the present embodiment will be described.

The pressurizing pump 20 pressurizes the inside of the liquid storage section 17. When the pressure in the liquid storage section 17 increases, the second valve mechanism 22 releases the pressure in the liquid storage section 17. The pressure in the liquid ejection section 12 decreases, for example, by ejection of the liquid. When the pressure of the liquid ejection section 12 decreases, the first valve mechanism 21 enables the liquid to flow from the liquid storage section 17 to the liquid ejection section 12.

### Effects of First Embodiment

Effects of the present embodiment will be described.
(1-1) The pressure of the first upstream chamber 24 operates on the second flexible membrane 27 and the first valve section 36. The pressure of the first upstream chamber 24 operating on the first valve section 36 and the pressure of the first upstream chamber 24 operating on the second flexible membrane 27 cancel each other out. Therefore, it is possible to open and close the first open and close section 28 by the fluctuation of the pressure of the first downstream chamber 25. Therefore, it is possible to reduce variations in the pressure of the fluid that flows out.
(1-2) The pressure of the second downstream chamber 40 operates on the fourth flexible membrane 42 and the second valve section 51. The pressure of the second downstream chamber 40 operating on the second valve section 51 and the pressure of the second downstream chamber 40 operating on the fourth flexible membrane 42 cancel each other out. Therefore, it is possible to open and close the second open and close section 43 by fluctuation of the pressure of the second upstream chamber 39. Therefore, it is possible to reduce the variation in the pressure of the inflowing fluid.
(1-3) One end of the first shaft section 35 is connected to the first flexible membrane 26, and the other end is connected to the first valve section 36. Therefore, for example, compared to a case where the first flexible membrane 26 and the first valve section 36 are connected an intermediate part of the first shaft section 35, it is possible to miniaturize the first valve mechanism 21.
(1-4) One end of the second shaft section 50 is connected to the third flexible membrane 41, and the other end is connected to the second valve section 51. Therefore, for example, compared to a case where the third flexible membrane 41 and the second valve section 51 are connected to an intermediate part of the second shaft section 50, it is possible to miniaturize the second valve mechanism 22.
(1-5) The first valve section 36 has the first seal section 37. The first seal section 37 can intimately contact the first communication port 32. Therefore, it is possible to enhance the sealing property of the first communication port 32. (1-6) The second valve section 51 has the second seal section 52. The second seal section 52 can intimately contact the second communication port 47. Therefore, it is possible to enhance the sealing property of the second communication port 47.
(1-7) The first flexible membrane 26 and the second flexible membrane 27, which are bent by receiving force, attempt to return to a state in which bending is minimized. In this regard, the bending amount of the first flexible membrane 26 and the second flexible membrane 27 is small when the first open and close section 28 is in the first closed state. Therefore, in the first closed state of the first open and close section 28, it is possible to stabilize the states of the first flexible membrane 26 and the second flexible membrane 27, and it is possible to reduce variations in the pressure of the fluid which flows out.
(1-8) The third flexible membrane 41 and the fourth flexible membrane 42, which are bent by receiving force, attempt to return to a state in which bending is minimized. In this regard, the bending amount of the third flexible membrane 41 and the fourth flexible membrane 42 is small when the second open and close section 43 is in the second closed state. Therefore, in the second closed state of the second open and close section 43, it is possible to stabilize the states of the third flexible membrane 41 and the fourth flexible membrane 42, and it is possible to reduce variations in the pressure of the fluid which flows in.
(1-9) The same pressure is applied to the second flexible membrane 27 and the first valve section 36. Therefore, by equalizing the pressure receiving areas of the second flexible membrane 27 and the first valve section 36, it is possible to easily cancel out the forces applied to the second flexible membrane 27 and the first valve section 36.
(1-10) The same pressure is applied to the fourth flexible membrane 42 and the second valve section 51. Therefore, by equalizing the pressure receiving areas of the fourth flexible membrane 42 and the second valve section 51, it is possible to easily cancel out the forces applied to the fourth flexible membrane 42 and the second valve section 51.
(1-11) The first valve mechanism 21 is provided in the liquid flow path 19. Therefore, it is possible to stabilize the pressure of the liquid flowing through the liquid flow path 19.
(1-12) The second valve mechanism 22 is capable of adjusting the pressure of the liquid storage section 17. Therefore, it is possible to stabilize the pressure of the liquid that is sent from the liquid storage section 17 to the liquid flow path 19.
(1-13) When the negative pressure in the first downstream chamber 25 increases, the first valve mechanism 21 brings the first open and close section 28 into the first open state. When the pressurization of the second upstream chamber 39 increases, the second valve mechanism 22 sets the second open and close section 43 to the second open state. Therefore, by using the first valve mechanism 21 and the second valve mechanism 22 in accordance with the pressure of the fluid, it is possible to stabilize the pressure of the positive pressure fluid and the negative pressure fluid.
(1-4) In the first valve mechanism 21, when a seal rubber is used instead of the second flexible membrane 27, the seal rubber may hinder movement of the first open and close section 28. In the second valve mechanism 22, when a seal rubber is used instead of the fourth flexible membrane 42, the seal rubber may hinder movement of the second open and close section 43. In a case where the movement of the open and close section is hindered, there is a concern that the variation in the pressure of the fluid that flows out or flows in increases. In this regard, the first valve mechanism 21 includes the second flexible membrane 27 that is displaced following the first open and close section 28. The second valve mechanism 22 includes a fourth flexible membrane 42 that is displaced following the second open and close section 43. Therefore, it is possible to reduce the variation in the pressure of the fluid that flows out or flows in by allowing the movement of the open and close section by the flexible film.

### Second Embodiment

Next, a second embodiment of the valve mechanism, the liquid fluid device, and the liquid ejection device will be described with reference to the drawings. The liquid fluid device of the second embodiment is different from that of the first embodiment. In other respects, the second embodiment is substantially the same as the first embodiment, so the same components are denoted by the same reference numerals, and redundant description thereof will be omitted.

### Liquid Fluid Device

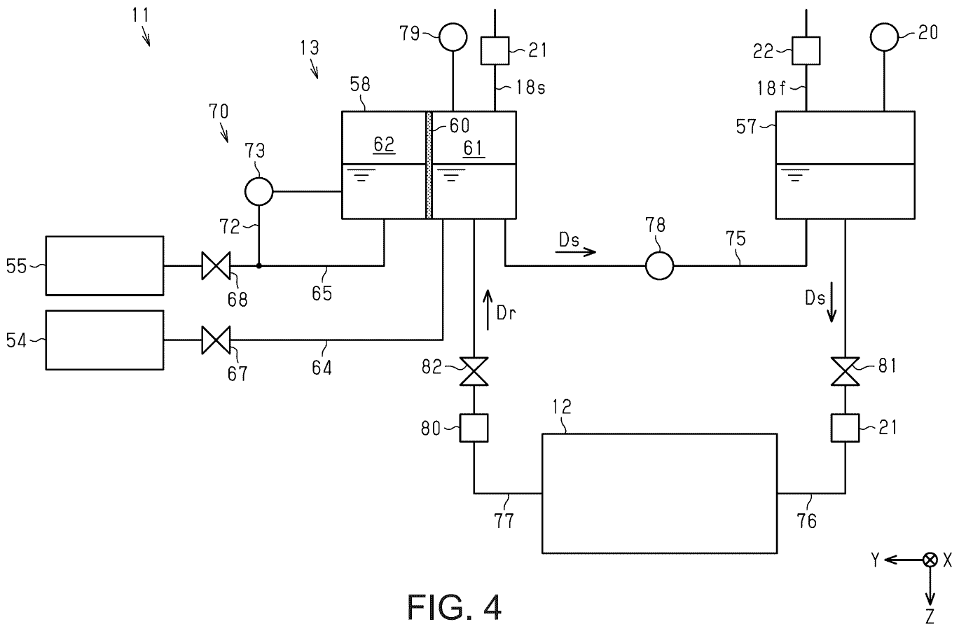

As shown in FIG. 4, the liquid fluid device 13 may cause humectant liquid to flow in addition to causing the liquid to flow. A humectant liquid is a liquid for moisturizing the liquid. The humectant liquid is, for example, a glycerin aqueous solution.

The liquid fluid device 13 may be connected to a liquid supply source 54 and a moisture supply source 55. The moisture supply source 55 contains moisture, namely water. The moisture supply source 55 may be a cartridge, a pack, or the like that is attachable to and detachable from the liquid ejection device 11, or may be a tank which can be replenished with liquid.

The liquid fluid device 13 may include a first tank 57, which is an example of a liquid storage section, and a second tank 58, which is also an example of a liquid storage section. The first tank 57 can accommodate the liquid to be supplied to the liquid ejection section 12. The second tank 58 can accommodate the liquid recovered from the liquid ejection section 12.

The second tank 58 may have a moisture permeable membrane 60. The moisture permeable membrane 60 partitions the inside of the second tank 58 into a liquid chamber 61 and a humectant liquid chamber 62. The liquid chamber 61 can accommodate liquid. Liquid is supplied to liquid chamber 61 from the liquid supply source 54. The humectant liquid chamber 62 can contain a humectant liquid. The humectant liquid chamber 62 is supplied with moisture from the moisture supply source 55.

The moisture permeable membrane 60 is a membrane that allows gases to pass through while preventing liquids from passing through. Therefore, the moisture permeable membrane 60 partitions the liquid and the humectant liquid from each other so that the liquid stored in the liquid chamber 61 and the humectant liquid stored in the humectant liquid chamber 62 do not mix together. The moisture permeable membrane 60 is a porous membrane in which a plurality of pores are formed. A meniscus is generated in the pores by surface tension of the liquid. As a result, the moisture permeable membrane 60 allows gas to permeate through it, while preventing the permeation of liquids. The humectant liquid moisturizes the liquid by supplying moisture to the liquid through the moisture permeable membrane 60.

The liquid fluid device 13 may include a liquid supply flow path 64 and a moisture supply flow path 65. The liquid supply flow path 64 is connected to the liquid supply source 54 and the liquid chamber 61. The moisture supply flow path 65 is connected to the moisture supply source 55 and the humectant liquid chamber 62.

The liquid fluid device 13 may include a liquid supply valve 67 and a moisture supply valve 68. The liquid supply valve 67 is positioned in the liquid supply flow path 64. When the liquid supply valve 67 is opened, the liquid can be supplied from the liquid supply source 54 to the second tank 58. The moisture supply valve 68 is positioned in the moisture supply flow path 65. When the moisture supply valve 68 is opened, moisture can be supplied from the moisture supply source 55 to the second tank 58. Normally, the liquid supply valve 67 and the moisture supply valve 68 are closed. The liquid supply valve 67 is opened when it is necessary to supply the liquid to the second tank 58. The moisture supply valve 68 is opened when it is necessary to supply moisture to the second tank 58.

The liquid fluid device 13 may include an agitation section 70. The agitation section 70 is attached to the second tank 58. The agitation section 70 agitates the humectant liquid stored in the humectant liquid chamber 62. The concentration of the humectant liquid is made uniform by the agitation section 70 agitating the humectant liquid. Accordingly, a concern that the concentration of the humectant liquid will increase is reduced.

The agitation section 70 may include an agitation flow path 72 and an agitation pump 73. The agitation flow path 72 is connected to the humectant liquid chamber 62 and the moisture supply flow path 65. The agitation pump 73 is located in the agitation flow path 72. The agitation pump 73 circulates the humectant liquid in the second tank 58 through the agitation flow path 72. Accordingly, the humectant liquid is agitated.

The liquid fluid device 13 may include a connection flow path 75, a positive pressure flow path 76, which is an example of a liquid flow path, a negative pressure flow path 77, which is an example of a liquid flow path, a first gas flow path 18f, and a second gas flow path 18s. The liquid fluid device 13 may include a liquid feed section 78, a pressurizing pump 20, and a pressure reduction pump 79, which is an example of a pressure varying mechanism. The liquid fluid device 13 may include a plurality of the first valve mechanisms 21, the second valve mechanism 22, a negative pressure adjustment valve 80, an upstream valve 81, and a downstream valve 82.

The connection flow path 75 connects the second tank 58 and the first tank 57 to each other. The liquid feed section 78 is positioned in the connection flow path 75. The liquid feed section 78 sends liquid from the second tank 58 to the first tank 57 via the connection flow path 75. The liquid feed section 78 sends liquid in the supply direction Ds.

The positive pressure flow path 76 is connected to the first tank 57. The upstream end of positive pressure flow path 76 in the supply direction Ds is connected to the first tank 57. The positive pressure flow path 76 has its downstream end in the supply direction Ds connected to the liquid ejection section 12. The positive pressure flow path 76 brings the first tank 57 and the liquid ejection section 12 into communication with each other. The positive pressure flow path 76 connects the first tank 57 and the liquid ejection section 12 in a state in which liquid can flow. The positive pressure flow path 76 sends the liquid from the first tank 57 to the liquid ejection section 12.

The upstream valve 81 and the first valve mechanism 21 are provided in the positive pressure flow path 76. The upstream valve 81 can open and close the positive pressure flow path 76. The first valve mechanism 21 is provided between the upstream valve 81 and the liquid ejection section 12. With respect to the first valve mechanism 21 provided in the positive pressure flow path 76, the first inflow port 31 communicates with the first tank 57, and the first outflow port 33 communicates with the liquid ejection section 12. When the negative pressure in the liquid ejection section 12 becomes larger than a predetermined negative pressure, the first valve mechanism 21 enters the first open state indicated by two-dot chain line in FIG. 2. When the first valve mechanism 21 enters the first open state, the liquid is supplied from the first tank 57 to the liquid ejection section 12.

The negative pressure flow path 77 is connected to the second tank 58. The downstream end of the negative pressure flow path 77 in a collection direction Dr is connected to the second tank 58. The upstream end of the negative pressure flow path 77 in the collection direction Dr is connected to the liquid ejection section 12. The negative pressure flow path 77 brings the liquid ejection section 12 and the second tank 58 into communication with each other. The negative pressure flow path 77 connects the liquid ejection section 12 and the second tank 58 in a state in which the liquid can flow. The negative pressure flow path 77 sends the liquid collected from the liquid ejection section 12 to the second tank 58.

The downstream valve 82 and the negative pressure adjustment valve 80 are provided in the negative pressure flow path 77. The downstream valve 82 can open and close the negative pressure flow path 77. The negative pressure adjustment valve 80 adjusts the negative pressure on the liquid ejection section 12 side. The negative pressure adjustment valve 80 reduces the magnitude of the negative pressure on the liquid ejection section 12 side to be less than the magnitude of the negative pressure on the second tank 58 side. The pressure of the liquid recovered from the liquid ejection section 12 is adjusted by the negative pressure adjustment valve 80. Therefore, the negative pressure applied to the liquid ejection section 12 is smaller than the reduced negative pressure in the second tank 58.

The first gas flow path 18f is connected to the first tank 57. One end of the first gas flow path 18f is connected to the first tank 57, and the other end is open to atmosphere. A second valve mechanism 22 is provided in the first gas flow path 18f. The second inflow port 46 of the second valve mechanism 22 is in communication with the first tank 57 and the second outflow port 48 is open to atmosphere. The second valve mechanism 22 is connected to the first tank 57. The second valve mechanism 22 can adjust the pressure of the first tank 57.

The second gas flow path 18s is connected to the second tank 58. For example, one end of the second gas flow path 18s is connected to the liquid chamber 61, and the other end is open to atmosphere. A first valve mechanism 21 is provided in the second gas flow path 18s. In the first valve mechanism 21 provided in the second gas flow path 18s, the first inflow port 31 is open to atmosphere and the first outflow port 33 is in communication with the liquid chamber 61. The first valve mechanism 21 is connected to the second tank 58. The first valve mechanism 21 can adjust the pressure of the second tank 58.

The pressurizing pump 20 can pressurize the inside of the first tank 57. The pressurizing pump 20 changes the pressure of the liquid flowing through the positive pressure flow path 76. The pressurizing pump 20 may pressurize the inside of the first tank 57 by sending air into the first tank 57. When the pressurizing pump 20 pressurizes the inside of the first tank 57, the liquid in the first tank 57 flows out to the positive pressure flow path 76. When the pressure in the first tank 57 exceeds a predetermined pressure, the second valve mechanism 22 enters the second open state to release the pressure in the first tank 57.

The pressure reduction pump 79 can reduce the pressure in the second tank 58. The pressure reduction pump 79 changes the pressure of the liquid flowing through the negative pressure flow path 77. The pressure reduction pump 79 may decompress the inside of the second tank 58 by drawing air from the inside of the second tank 58. The pressure reduction pump 79 normally depressurizes the inside of the second tank 58 so that the inside of the liquid ejection section 12 is maintained at a predetermined negative pressure. When the negative pressure in the second tank 58 becomes greater than a predetermined negative pressure, the first valve mechanism 21 enters the first open state to allow air to flow into the first tank 57.

When the pressure reduction pump 79 reduces the pressure in the second tank 58, the liquid flows into the second tank 58. For example, when the pressure reduction pump 79 is driven while the liquid supply valve 67 is in an open state, the liquid flows from the liquid supply source 54 into the second tank 58 through the liquid supply flow path 64. When the pressure reduction pump 79 is driven while the moisture supply valve 68 is in an open state, the liquid flows from the moisture supply source 55 into the second tank 58 through the moisture supply flow path 65. When the pressure reduction pump 79 is driven with the liquid supply valve 67 and the moisture supply valve 68 in a closed state, the liquid flows from the liquid ejection section 12 into the second tank 58 through the negative pressure flow path 77.

The connection flow path 75, the positive pressure flow path 76, and the negative pressure flow path 77 circulate the liquid and also supply the liquid to the liquid ejection section 12. When the liquid is circulated, it flows from the second tank 58 to the first tank 57 through the connection flow path 75. When the liquid is circulated, it flows from the first tank 57 to the liquid ejection section 12 through the positive pressure flow path 76. When the liquid is circulated, it flows from the liquid ejection section 12 to the second tank 58 through the negative pressure flow path 77. The positive pressure flow path 76 is a flow path for supplying liquid to the liquid ejection section 12. The negative pressure flow path 77 is a flow path for recovering the liquid from the liquid ejection section 12.

### Operation of Second Embodiment

The operation of the present embodiment will be described.

The pressure of the liquid supplied from the first tank 57 to the liquid ejection section 12 is adjusted by the first valve mechanism 21. Therefore, the liquid having a pressure lower than the pressure in the pressurized first tank 57 is supplied to the liquid ejection section 12.

The pressure of the liquid recovered from the liquid ejection section 12 is adjusted by the negative pressure adjustment valve 80. Therefore, the negative pressure applied to the liquid ejection section 12 is smaller than the reduced negative pressure in the second tank 58.

### Effects of Second Embodiment

Effects of the present embodiment will be described.
(2-1) The connection flow path 75 connects the second tank 58, which is connected to the negative pressure flow path 77, to the first tank 57, which is connected to the positive pressure flow path 76. Therefore, the liquid recovered from the liquid ejection section 12 can be supplied to the liquid ejection section 12 again.

### MODIFICATIONS

The present embodiment can be implemented with the following modifications. The embodiments and the following modifications can be implemented in combination with each other as long as there is no technical contradiction.

### First Modification

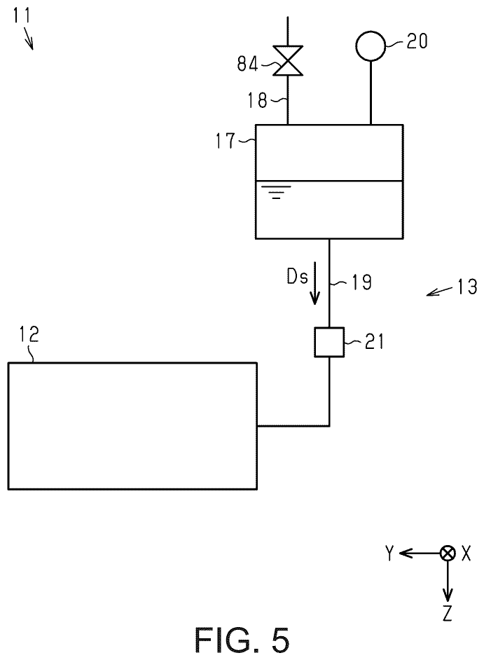

As shown in FIG. 5, the liquid ejection device 11 may include an atmosphere release valve 84. The atmosphere release valve 84 may be provided in the gas flow path 18. The atmosphere release valve 84 can open the inside of the liquid storage section 17 to atmosphere. The atmosphere release valve 84 can change the pressure applied to the liquid in the liquid storage section 17 to atmospheric pressure.

### Second Modification

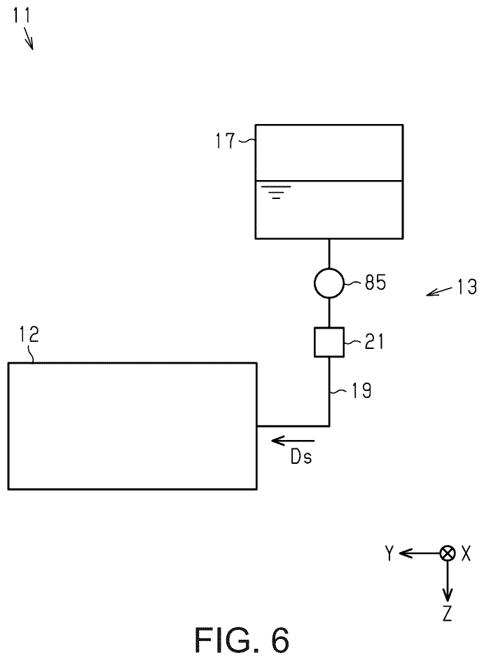

As shown in FIG. 6, the liquid ejection device 11 may include a liquid pump 85. The liquid pump 85 may be provided in the liquid flow path 19 between the liquid storage section 17 and the first valve mechanism 21. The liquid pump 85 causes the liquid in the liquid flow path 19 to flow in the supply direction Ds.

### Third Modification

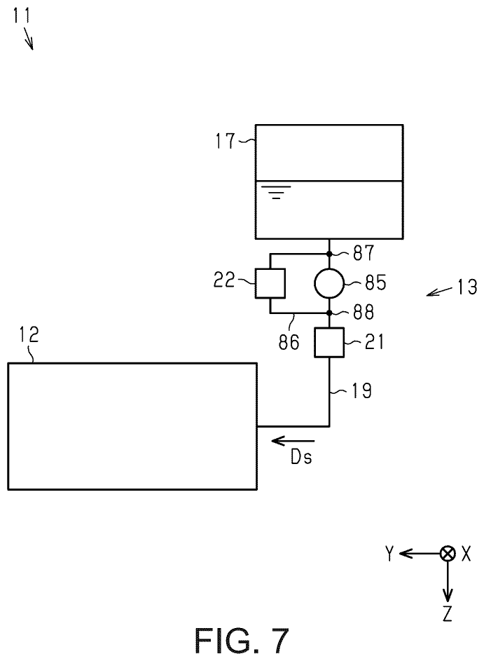

As shown in FIG. 7, the liquid ejection device 11 may include a relief flow path 86. The second valve mechanism 22 may be provided in the relief flow path 86.

The relief flow path 86 connects a first connection section 87 and a second connection section 88 in the liquid flow path 19. The first connection section 87 is provided between the liquid storage section 17 and the liquid pump 85 in the supply direction Ds. The second connection section 88 is provided between the liquid pump 85 and the first valve mechanism 21 with respect to the supply direction Ds. In the second valve mechanism 22, the second inflow port 46 communicates with the second connection section 88 via the relief flow path 86. In the second valve mechanism 22, the second outflow port 48 communicates with the first connection section 87 via the relief flow path 86.

The second valve mechanism 22 enters the open state shown in FIG. 3 when the pressure of the second connection section 88 becomes higher than a predetermined pressure. When the second valve mechanism 22 is in the open state, the liquid circulates in the liquid flow path 19 between the first connection section 87 and the second connection section 88, as well as in the relief flow path 86. The second valve mechanism 22 limits the pressure applied to the liquid in the liquid flow path 19.

### Fourth Modification

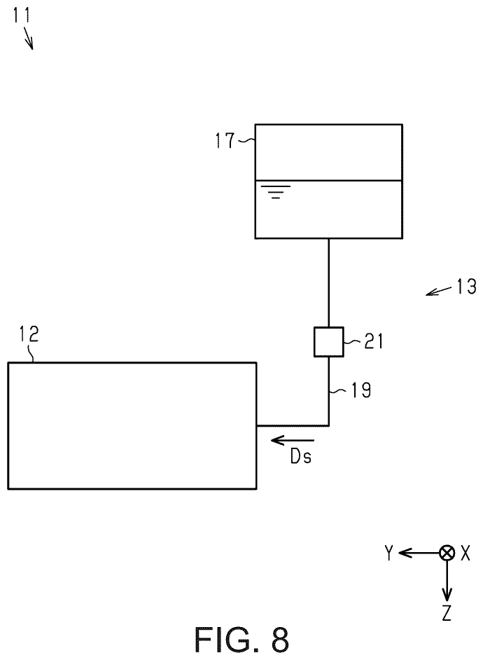

As shown in FIG. 8, the liquid ejection device 11 may supply the liquid stored in the liquid storage section 17 to the liquid ejection section 12 using a water head. In this case, the liquid ejection device 11 may be configured without including the pressurizing pump 20 and the liquid pump 85.

### Fifth Modification

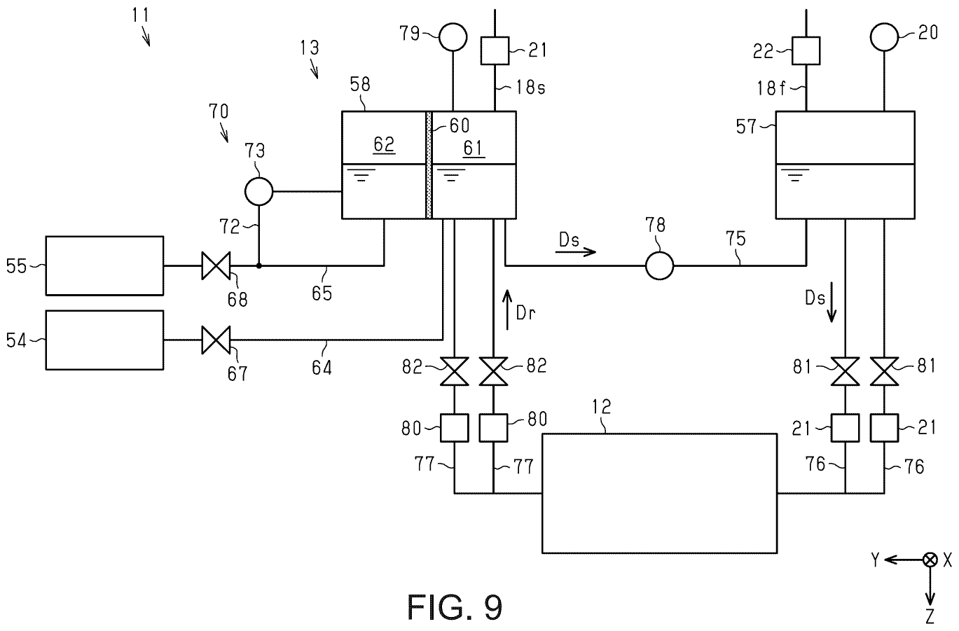

As shown in FIG. 9, the liquid ejection device 11 may include a plurality of positive pressure flow paths 76. The plurality of positive pressure flow paths 76 may merge further upstream in the supply direction Ds than the liquid ejection section 12. An upstream valve 81 and a first valve mechanism 21 may be provided in each of the plurality of positive pressure flow paths 76. Plural first valve mechanisms 21 may be provided in parallel.

The liquid ejection device 11 may include a plurality of negative pressure flow paths 77. The negative pressure flow path 77 may be branched into a plurality of paths downstream in the collection direction Dr of the liquid ejection section 12. Each of the plurality of negative pressure flow paths 77 may be provided with a downstream valve 82 and a negative pressure adjustment valve 80. A plurality of negative pressure adjustment valves 80 may be provided in parallel.

The plurality of first valve mechanisms 21 provided in the plurality of positive pressure flow paths 76 may enter the open state at different pressures. The plural negative pressure adjustment valves 80 provided in the plural negative pressure flow paths 77 may have different pressures after adjustment.

The liquid ejection device 11 may select the first valve mechanism 21 and the negative pressure adjustment valve 80 to be used by opening and closing the upstream valve 81 and the downstream valve 82. For example, in a case where the liquid is circulated, the liquid ejection device 11 may use a first valve mechanism 21 that has a small pressure after adjustment and a negative pressure adjustment valve 80 that has a small negative pressure after adjustment. At the time of circulation, a low pressure liquid may be supplied to the liquid ejection section 12, and a small negative pressure may be applied to the liquid ejection section 12.

For example, when the liquid ejection section 12 is being filled with liquid, the liquid ejection device 11 may use a first valve mechanism 21 that has a large pressure after adjustment and a negative pressure adjustment valve 80 that has a large negative pressure after adjustment. That is, at the time of filling, a liquid having a high pressure may be supplied to the liquid ejection section 12, and a high negative pressure may be applied to the liquid ejection section 12.

### Sixth Modification

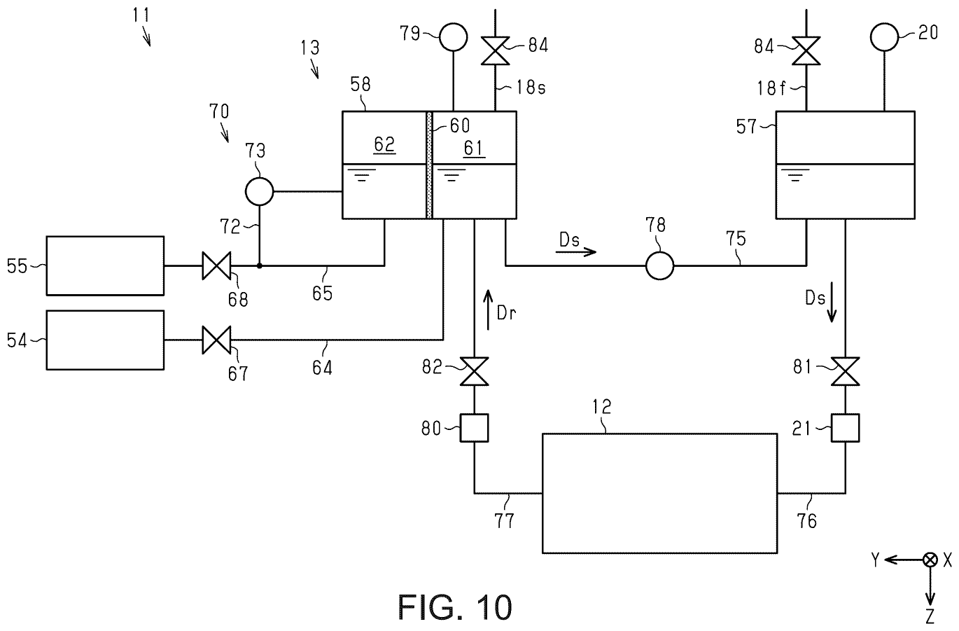

As shown in FIG. 10, the liquid ejection device 11 may include a plurality of atmosphere release valves 84. An atmosphere release valve 84 may be provided in the first gas flow path 18f and in the second gas flow path 18s. The atmosphere release valve 84 provided in the first gas flow path 18f can open the inside of the first tank 57 to atmosphere. The atmosphere release valve 84 provided in the second gas flow path 18s can open the inside of the second tank 58 to atmosphere.

### Seventh Modification

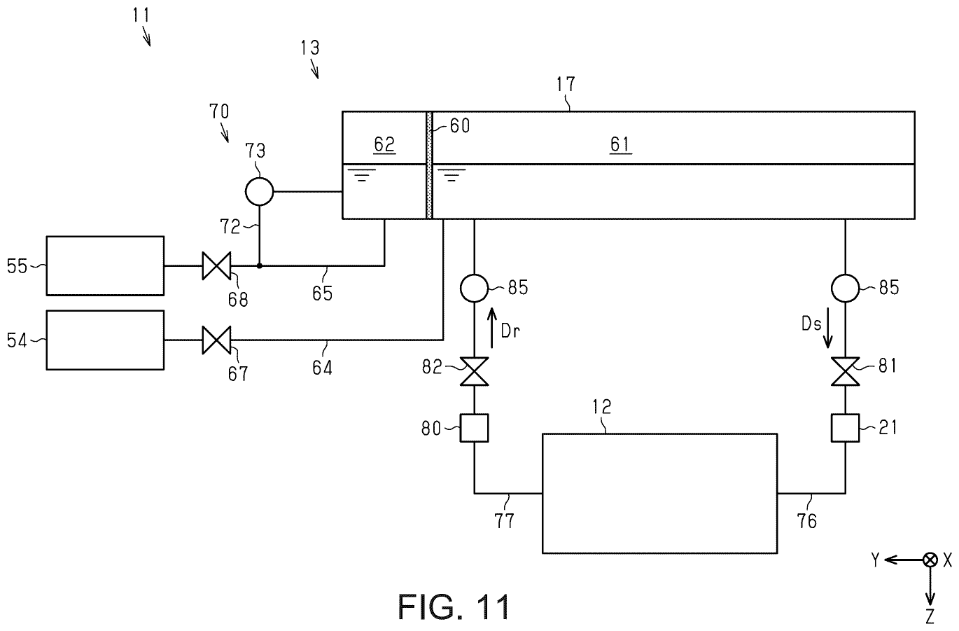

As shown in FIG. 11, the liquid storage section 17 may have a moisture permeable membrane 60. The moisture permeable membrane 60 may divide the inside of the liquid storage section 17 into a liquid chamber 61 and a humectant liquid chamber 62. The positive pressure flow path 76 at the upstream end in the supply direction Ds may be connected to the liquid storage section 17. The downstream end of the negative pressure flow path 77 in the collection direction Dr may be connected to the liquid storage section 17. The liquid pump 85 may be provided in the positive pressure flow path 76 between the liquid storage section 17 and the upstream valve 81. The liquid pump 85 may be provided in the negative pressure flow path 77 between the downstream valve 82 and the liquid storage section 17.

### Eighth Modification

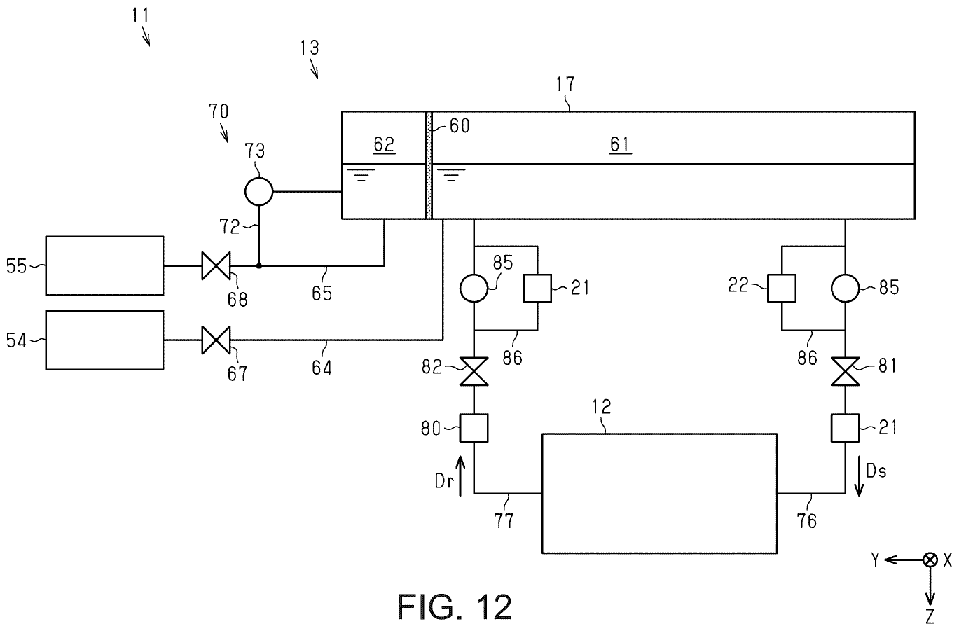

As shown in FIG. 12, the liquid ejection device 11 may include a plurality of relief flow paths 86. The second valve mechanism 22 may be provided in the relief flow path 86 connected to the positive pressure flow path 76. The second valve mechanism 22 circulates the liquid in the relief flow path 86 when the pressure downstream of the liquid pump 85 in the supply direction Ds becomes higher than a predetermined pressure.

The first valve mechanism 21 may be provided in the relief flow path 86 connected to the negative pressure flow path 77. The first valve mechanism 21 circulates the liquid in the relief flow path 86 when the negative pressure on the upstream side of the liquid pump 85 in the collection direction Dr becomes larger than a predetermined negative pressure.

### Ninth Modification

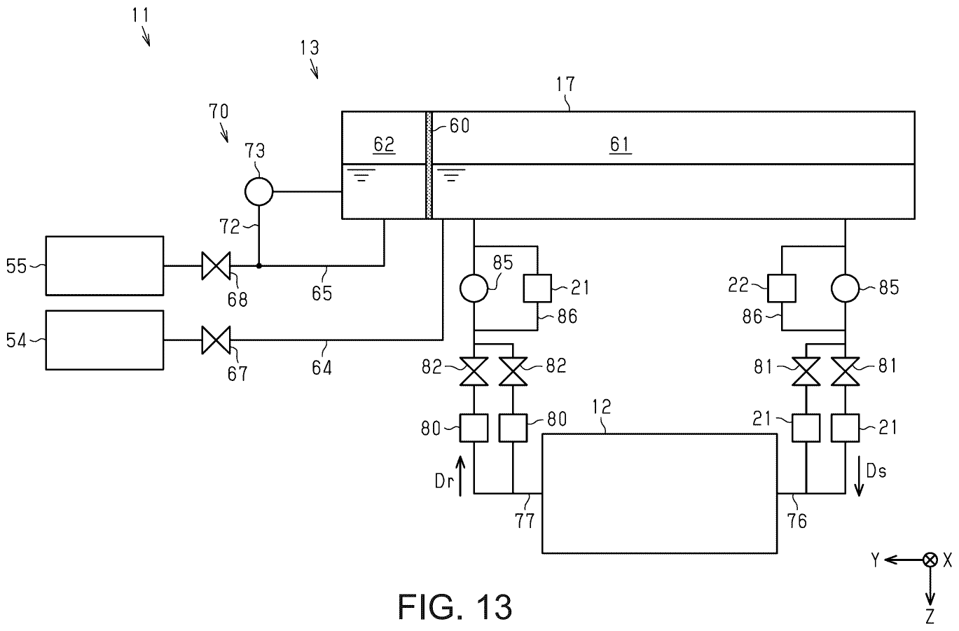

As illustrated in FIG. 13, the positive pressure flow path 76 may branch into a plurality of flow paths on the downstream side of the relief flow path 86 in the supply direction Ds and may merge on the upstream side of the liquid ejection section 12 in the supply direction Ds. An upstream valve 81 and a first valve mechanism 21 may be provided in each of the branched positive pressure flow paths 76. Plural first valve mechanisms 21 may be provided in parallel.

The negative pressure flow path 77 may branch into a plurality of paths downstream of the liquid ejection section 12 in the collection direction Dr and may merge upstream of the relief flow path 86 in the collection direction Dr. Each of the plurality of negative pressure flow paths 77 may be provided with a downstream valve 82 and a negative pressure adjustment valve 80. A plurality of negative pressure adjustment valves 80 may be provided in parallel.

### Tenth Modification

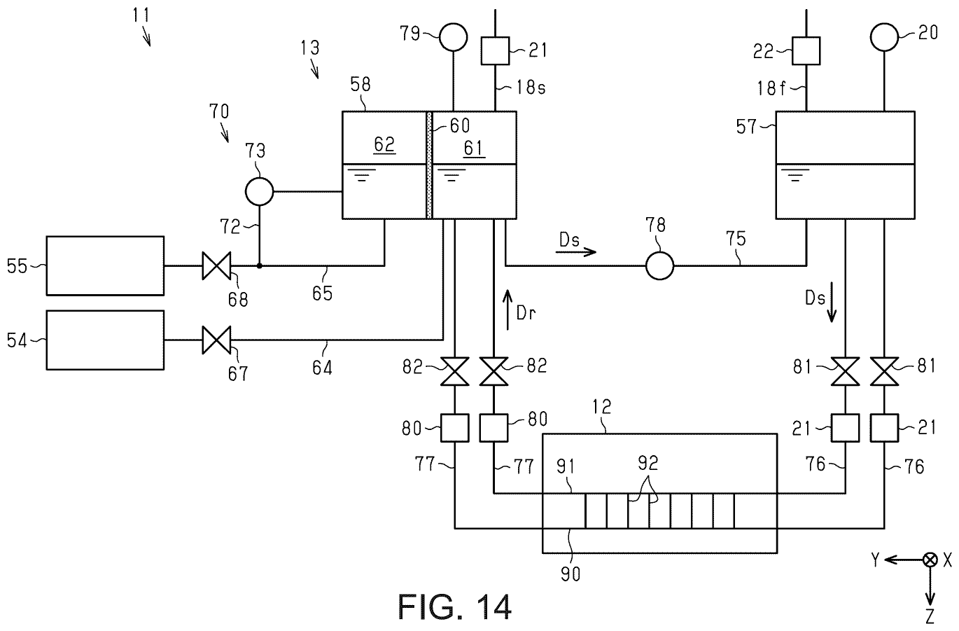

As shown in FIG. 14, a plurality of positive pressure flow paths 76 may each be connected to the liquid ejection section 12. A plurality of negative pressure flow paths 77 may each be connected to the liquid ejection section 12. The liquid ejection section 12 may include a high pressure flow path 90, a low pressure flow path 91, and a plurality of pressure difference flow paths 92.

A plurality of first valve mechanisms 21 provided in the plurality of positive pressure flow paths 76 have different pressures at which they enter the open state. A plural negative pressure adjustment valves 80 provided in the negative pressure flow paths 77 have different pressures after adjustment.

The high pressure flow path 90 and the low pressure flow path 91 each connect a positive pressure flow path 76 and a negative pressure flow path 77 together. Each of the plurality of pressure difference flow paths 92 connects the high pressure flow path 90 and the low pressure flow path 91 together. The liquid in the high pressure flow path 90 has a higher pressure than the liquid in the low pressure flow path 91. Therefore, the liquid flows from the high pressure flow path 90 toward the low pressure flow path 91 through the pressure difference flow path 92. The nozzle 15 may be provided in the pressure difference flow path 92.

### Eleventh Modification

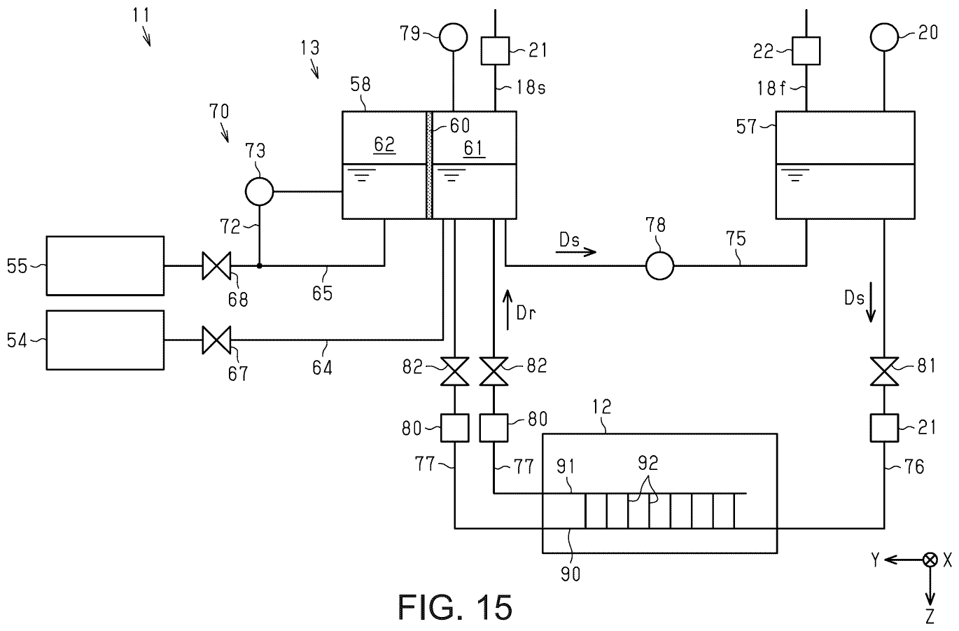

As shown in FIG. 15, the liquid ejection device 11 may include a single positive pressure flow path 76 and a plurality of negative pressure flow paths 77. The positive pressure flow path 76 is connected to the first tank 57 and the high pressure flow path 90.

### Twelfth Modification

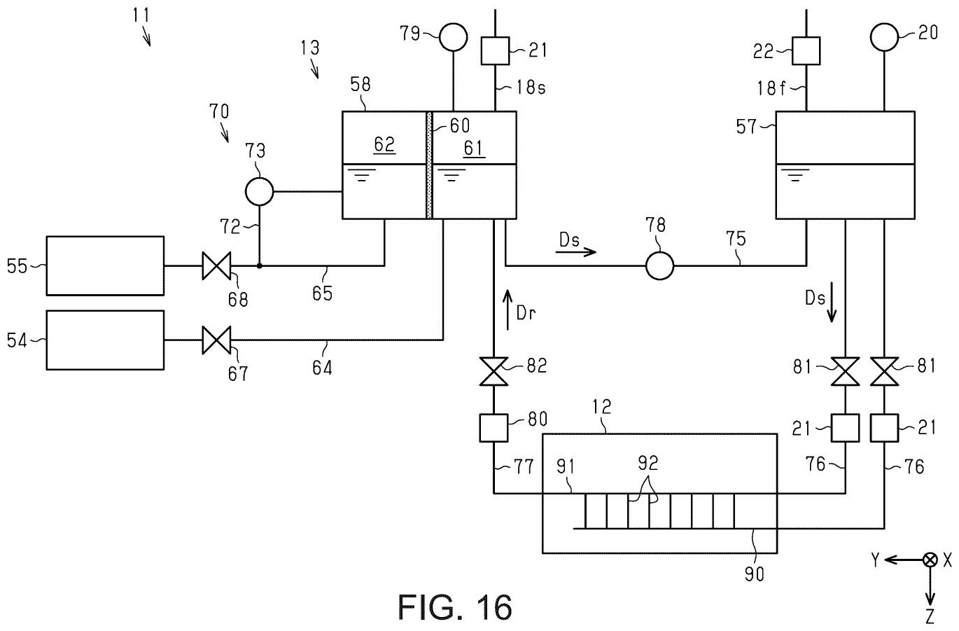

As shown in FIG. 16, the liquid ejection device 11 may include a plurality of positive pressure flow paths 76 and a single negative pressure flow path 77. The negative pressure flow path 77 is connected to the low pressure flow path 91 and the second tank 58.

### Thirteenth Modification

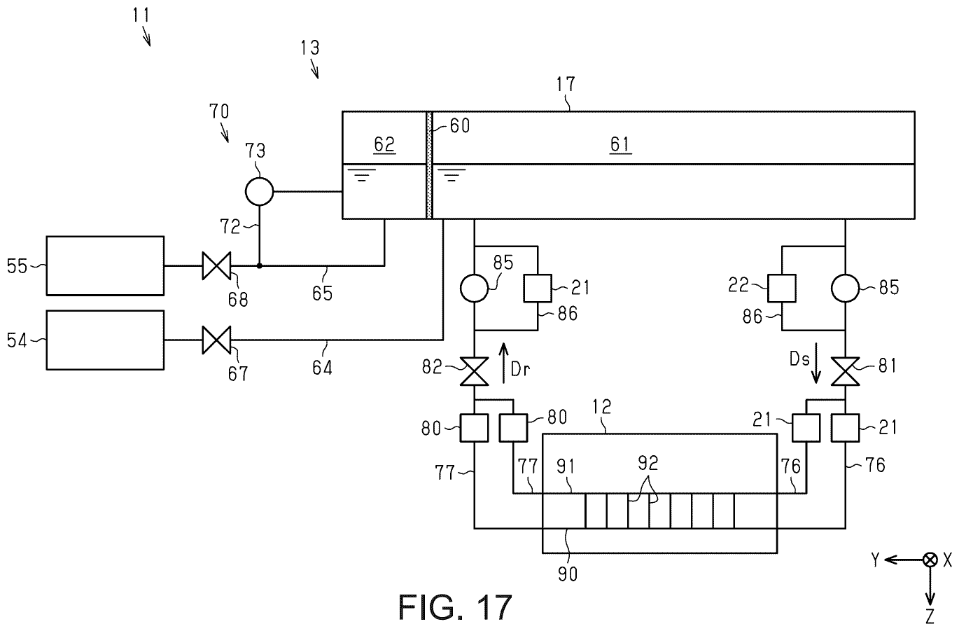

As shown in FIG. 17, the positive pressure flow path 76 may branch downstream of the upstream valve 81 in the supply direction Ds. A first valve mechanism 21 may be provided in each of the branched positive pressure flow paths 76. The branched positive pressure flow paths 76 may be connected to the high pressure flow path 90 and the low pressure flow path 91.

A plurality of negative pressure flow paths 77 may be connected to the high pressure flow path 90 and the low pressure flow path 91. Each of the plurality of negative pressure flow paths 77 may be provided with a negative pressure adjustment valve 80. The plurality of negative pressure flow paths 77 may merge upstream of the downstream valve 82 in the collection direction Dr.

### Fourteenth Modification

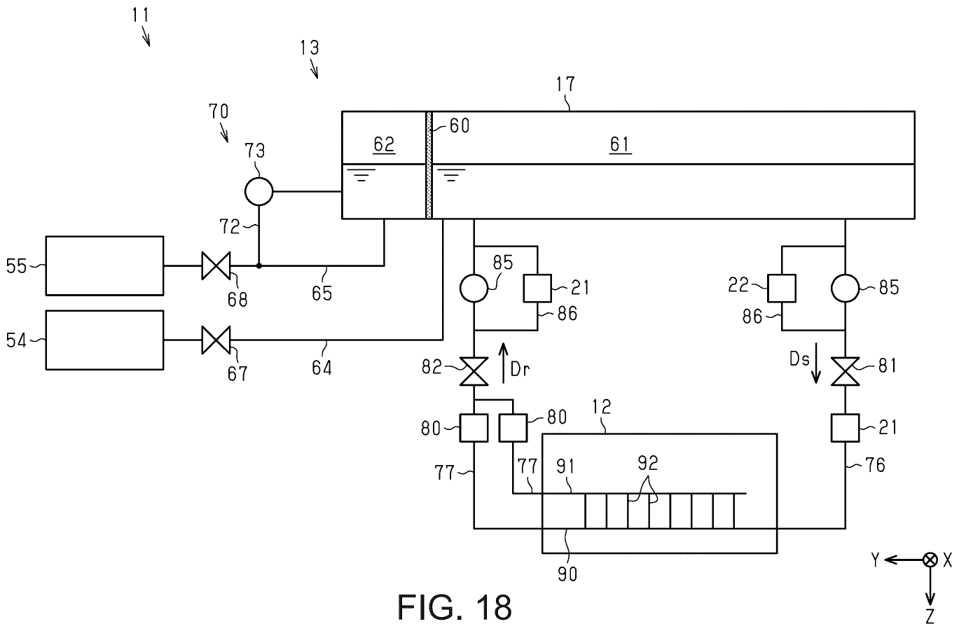

As shown in FIG. 18, the positive pressure flow path 76 may connect the liquid storage section 17 and the high pressure flow path 90 together. A plurality of negative pressure flow paths 77 connected to the high pressure flow path 90 and the low pressure flow path 91 may merge upstream of the downstream valve 82 in the collection direction Dr.

### Fifteenth Modification

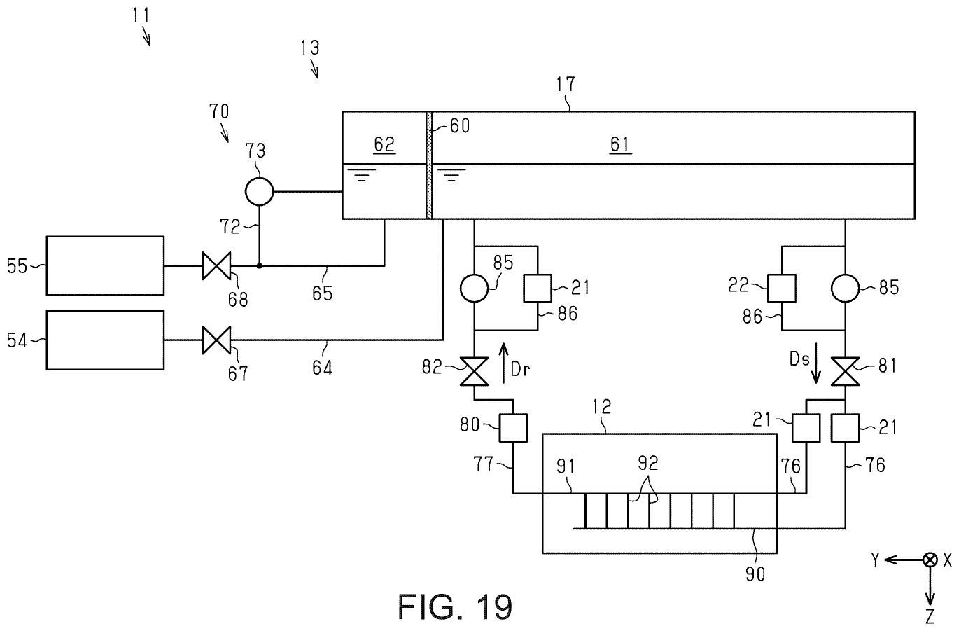

As shown in FIG. 19, the positive pressure flow path 76 may branch downstream of the upstream valve 81 in the supply direction Ds and may be connected to the high pressure flow path 90 and to the low pressure flow path 91. The negative pressure flow path 77 may connect the low pressure flow path 91 and the liquid storage section 17.

### OTHER MODIFICATIONS

The liquid ejection device 11 may be configured to include either the first valve mechanism 21 or the second valve mechanism 22. The liquid ejection device 11 may supply the liquid by controlling the pressurizing pump 20, the pressure reduction pump 79, atmosphere release valve 84, the upstream valve 81, the downstream valve 82, or the like.
In the first upstream chamber 24, the pressure receiving area of the second flexible membrane 27 may be different from the pressure receiving area of the first valve section 36. In the second downstream chamber 40, the pressure receiving area of the fourth flexible membrane 42 may be different from the pressure receiving area of the second valve section 51. The first valve mechanism 21 and the second valve mechanism 22 may adjust the pressure receiving area in accordance with posture, the type of fluid to be handled, the ease of deformation of the second flexible membrane 27 or the fourth flexible membrane 42, or the like.
The bending amount of the first flexible membrane 26 when the first open and close section 28 is in the first closed state may be greater than the bending amount of the first flexible membrane 26 when the first open and close section 28 is in the first open state.
The bending amount of the third flexible membrane 41 when the second open and close section 43 is in the second closed state may be larger than the bending amount of the third flexible membrane 41 when the second open and close section 43 is in the second open state.
The bending amount of the second flexible membrane 27 when the first open and close section 28 is in the first closed state may be greater than the bending amount of the second flexible membrane 27 when the first open and close section 28 is in the first open state.
The bending amount of the fourth flexible membrane 42 when the second open and close section 43 is in the second closed state may be larger than the bending amount of the fourth flexible membrane 42 when the second open and close section 43 is in the second open state.
The first seal section 37 may be provided in the first communication port 32. The second seal section 52 may be provided in the second communication port 47.
The first shaft section 35 and the second flexible membrane 27 may be integrally formed. The second shaft section 50 and the fourth flexible membrane 42 may be integrally formed.
The liquid ejection device 11 may be a liquid ejection device that ejects or discharges liquid other than ink. The state of the liquid which is discharged from the liquid ejection device in the form of a minute amount of liquid droplets includes a granular shape, a tear shape, and a shape with a thread-like tail. Here, the liquid may be any material that can be ejected from the liquid ejection device. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include ink as described in the above embodiment and liquid crystal. Here, ink encompasses various liquid compositions such as general water-based ink, oil-based ink, gel ink, and hot-melt ink. As a specific example of the liquid ejection device, there is an apparatus that ejects a liquid containing, in a dispersed or dissolved form, a material such as an electrode material or a color material used for manufacturing a liquid crystal display, an electroluminescence display, a surface emitting display, a color filter, or the like. The liquid ejection device may be a device that ejects a bio-organic substance used for manufacturing a biochip, a device that is used as a precision pipette and that ejects a liquid serving as a sample, a textile printing device, a micro dispenser, or the like. The liquid ejection device may be a device that discharges lubricating oil in a pinpoint manner to precision machinery such as watches or cameras, or a device that discharges a transparent resin liquid, such as an ultraviolet curable resin, onto a substrate to form micro hemispherical lenses, optical lenses, or the like used in optical communication elements. The liquid ejection device may be a device that ejects an etching solution such as an acid or an alkali for etching a substrate or the like.

### Definitions

As used herein, the phrase “at least one” means “one or more” of the desired alternatives. As an example, the phrase “at least one” as used herein means “only one option” or “both of two options” if the number of options is two. As another example, as used herein, the phrase “at least one” means “only one option”, “a combination of two options”, or “a combination of three or more options” if the number of options is three or more.

### SUPPLEMENTARY NOTES

Hereinafter, technical ideas grasped from the above-described embodiment and modifications, and operations and effects thereof will be described.
(A) A valve mechanism includes an upstream chamber into which fluid flows via an inflow port; a downstream chamber that has a first flexible membrane and that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction of increasing volume of the downstream chamber, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

According to this configuration, the pressure of the upstream chamber operates on the second flexible membrane and the valve section. The pressure of the upstream chamber operating on the valve section and the pressure of the upstream chamber operating on the second flexible membrane cancel each other out. Therefore, the opening and closing of the open and close section can be performed by fluctuation of the pressure in the downstream chamber. Therefore, it is possible to reduce variations in the pressure of the fluid that flows out.
(B) A valve mechanism includes an upstream chamber that has a first flexible membrane and into which a fluid flows via an inflow port; a downstream chamber that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction of decreasing volume of the upstream chamber, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

According to this configuration, the pressure of the downstream chamber operates on the second flexible membrane and the valve section. The pressure of the downstream chamber operating on the valve section and the pressure of the downstream chamber operating on the second flexible membrane cancel each other out. Therefore, opening and closing of the open and close section can be performed by fluctuation of the pressure in the upstream chamber. Therefore, it is possible to reduce the variation in the pressure of the inflowing fluid.
(C) The valve mechanism according to (A) or (B) may be such that the shaft section is inserted into the second flexible membrane, one end of the shaft section is connected to the first flexible membrane and an other end of the shaft section is connected to the valve section.

According to this configuration, one end of the shaft section is connected to the first flexible membrane, and the other end is connected to the valve section. Therefore, for example, compared to a case where the first flexible membrane and the valve section are connected to an intermediate part of the shaft section, the valve mechanism can be miniaturized.
(D) The valve mechanism according to (A) to (C) may be such that the valve section has a seal section configured to intimately contact the communication port.

According to this configuration, the valve section has the seal section. The seal section can intimately contact the communication port. Therefore, the sealing property of the communication port can be enhanced.
(E) The valve mechanism according to (A) to (D) may be such that a bending amount of the first flexible membrane when the open and close section is in a closed state is smaller than a bending amount of the first flexible membrane when the open and close section is in an open state and the bending amount of the second flexible membrane when the open and close section is in a closed state is smaller than the bending amount of the second flexible membrane when the open and close section is in an open state.

The first flexible membrane and the second flexible membrane, which are bent by receiving force, try to return to a state where bending is minimal. In this regard, according to this configuration, the bending amount of the first flexible membrane and the second flexible membrane is small when the open and close section is in the closed state. Therefore, it is possible to stabilize the states of the first flexible membrane and the second flexible membrane in the closed state of the open and close section.
(F) The valve mechanism according to (A) to (E) may be such that a pressure receiving area of the second flexible membrane and a pressure receiving area of the valve section are the same.

According to this configuration, the same pressure is applied to the second flexible membrane and the valve section. Therefore, by equalizing the pressure receiving areas of the second flexible membrane and the valve section, it is possible to easily cancel out the forces applied to the second flexible membrane and the valve section.
(G) A liquid fluid device including a liquid storage section configured to store liquid; a liquid flow path coupled to the liquid storage section; a pressure varying mechanism configured to vary the pressure of liquid flowing through the liquid flow path; and the valve mechanism according to (A) to (F).

According to this configuration, it is possible to achieve the same effect as that of the valve mechanism.
(H) The liquid fluid device according to (G) may be such that the valve mechanism is provided in the liquid flow path.

According to this configuration, the valve mechanism is provided in the liquid flow path. Therefore, it is possible to stabilize the pressure of the liquid flowing through the liquid flow path.
(J) The liquid fluid device according to (G) may be such that the valve mechanism is configured to adjust pressure of the liquid storage section.

According to this configuration, the valve mechanism can adjust the pressure of the liquid storage section. Therefore, it is possible to stabilize the pressure of the liquid which is sent from the liquid storage section to the liquid flow path.
(K) The liquid fluid device according to (G), further including a second valve mechanism, wherein, assuming that the valve mechanism is a first valve mechanism, the inflow port is a first inflow port, the upstream chamber is a first upstream chamber, the first communication port is a first communication port, the downstream chamber is a first downstream chamber, the first open and close section is a first open and close section, the biasing portion is a first biasing section, the shaft section is a first shaft section, and the valve section is a first valve section, the second valve mechanism includes a second upstream chamber that includes a third flexible membrane and into which fluid flows via a second inflow port, a second downstream chamber that is in communication with the second upstream chamber via a second communication port downstream of the second upstream chamber, a fourth flexible membrane that partitions the second upstream chamber and the second downstream chamber from each other, a second open and close section configured to open and close the second communication port, and a second biasing section that biases the third flexible membrane in a direction of decreasing volume of the second upstream chamber and the second open and close section includes a second shaft section that is provided across the second upstream chamber and the second downstream chamber and that is configured to move following displacement of the third flexible membrane and the fourth flexible membrane and a second valve section that is connected to the second shaft section and that opens and closes the second communication port.

According to this configuration, when the negative pressure in the first downstream chamber increases, the first valve mechanism causes the open and close section to enter the open state. The second valve mechanism brings the open and close section into an open state when the pressure in the second upstream chamber increases. Therefore, by using the first valve mechanism and the second valve mechanism in accordance with the fluid pressure, it is possible to stabilize the pressure of both the positive pressure fluid and the negative pressure fluid.
(L) A liquid ejection device includes a liquid fluid device according to (G) to (K) and a liquid ejection section configured to eject liquid.

According to this configuration, it is possible to achieve the same effect as that of the valve mechanism.

What is claimed is:

1. A valve mechanism comprising:
an upstream chamber into which fluid flows via an inflow port;
a downstream chamber that has a first flexible membrane and that is in communication with the upstream chamber via a communication port downstream of the upstream chamber;
a second flexible membrane that partitions the upstream chamber and the downstream chamber from each other;
an open and close section configured to open and close the communication port; and
a biasing section that biases the first flexible membrane in a direction of increasing volume of the downstream chamber, wherein
the open and close section includes
a shaft section that is provided across the upstream chamber and the downstream chamber and that is configured to move following displacement of the first flexible membrane and the second flexible membrane and
a valve section that is connected to the shaft section and that opens and closes the communication port.

2. A valve mechanism comprising:
an upstream chamber that has a first flexible membrane and into which a fluid flows via an inflow port;
a downstream chamber that is in communication with the upstream chamber via a communication port downstream of the upstream chamber;
a second flexible membrane that partitions the upstream chamber and the downstream chamber from each other;
an open and close section configured to open and close the communication port; and
a biasing section that biases the first flexible membrane in a direction of decreasing volume of the upstream chamber, wherein
the open and close section includes
a shaft section that is provided across the upstream chamber and the downstream chamber and that is configured to move following displacement of the first flexible membrane and the second flexible membrane and
a valve section that is connected to the shaft section and that opens and closes the communication port.

3. The valve mechanism according to claim 1, wherein
the shaft section is inserted into the second flexible membrane,
one end of the shaft section is connected to the first flexible membrane, and
an other end of the shaft section is connected to the valve section.

4. The valve mechanism according to claim 1, wherein
the valve section has a seal section configured to intimately contact the communication port.

5. The valve mechanism according to claim 1, wherein
a bending amount of the first flexible membrane when the open and close section is in a closed state is smaller than a bending amount of the first flexible membrane when the open and close section is in an open state and
a bending amount of the second flexible membrane when the open and close section is in the closed state is smaller than a bending amount of the second flexible membrane when the open and close section is in the open state.

6. A valve mechanism according to claim 1, wherein
a pressure receiving area of the second flexible membrane and a pressure receiving area of the valve section are the same.

7. A liquid fluid device comprising:
a liquid storage section configured to store liquid;
a liquid flow path coupled to the liquid storage section;
a pressure varying mechanism configured to vary the pressure of liquid flowing through the liquid flow path; and
the valve mechanism according to claim 1.

8. A Liquid fluid device comprising:
a liquid storage section configured to store liquid;
a liquid flow path coupled to the liquid storage section;
a pressure varying mechanism configured to vary the pressure of liquid flowing through the liquid flow path; and
the valve mechanism according to claim 2.

9. The liquid fluid device according to claim 7, wherein
the valve mechanism is provided in the liquid flow path.

10. The liquid fluid device according to claim 7, wherein
the valve mechanism is configured to adjust pressure of the liquid storage section.

11. The liquid fluid device according to claim 7, further comprising:
a second valve mechanism, wherein, assuming that
the valve mechanism is a first valve mechanism,
the inflow port is a first inflow port,
the upstream chamber is a first upstream chamber,
the first communication port is a first communication port,
the downstream chamber is a first downstream chamber,
the first open and close section is a first open and close section,
the biasing portion is a first biasing section,
the shaft section is a first shaft section, and
the valve section is a first valve section,
the second valve mechanism includes
a second upstream chamber that includes a third flexible membrane and into which fluid flows via a second inflow port,
a second downstream chamber that is in communication with the second upstream chamber via a second communication port downstream of the second upstream chamber,
a fourth flexible membrane that partitions the second upstream chamber and the second downstream chamber from each other,
a second open and close section configured to open and close the second communication port, and
a second biasing section that biases the third flexible membrane in a direction of decreasing volume of the second upstream chamber and
the second open and close section includes
a second shaft section that is provided across the second upstream chamber and the second downstream chamber and that is configured to move following displacement of the third flexible membrane and the fourth flexible membrane and
a second valve section that is connected to the second shaft section and that opens and closes the second communication port.

12. A liquid ejection device comprising:
the liquid fluid device according to claim 7 and
a liquid ejection section configured to eject liquid.
